(19) United States
(12) Patent Application Publication
(10) Pub. No.: US 2026/0244989 A1
(43) Pub. Date: Aug. 20, 2026

(54) INFORMATION PROCESSING DEVICE, INFORMATION PROCESSING SYSTEM, AND INFORMATION PROCESSING METHOD

(71) Applicant: Hitachi, Ltd., Tokyo (JP)

(72) Inventors: Masayuki TAKASE, Tokyo (JP); Takahito TANIMURA, Tokyo (JP); Yuichi KITAGAWA, Tokyo (JP)

(21) Appl. No.: 19/448,935

(22) Filed: Jan. 14, 2026

(30) Foreign Application Priority Data
Feb. 19, 2025 (JP) 2025-025383

(51) Int. Cl. G06N 20/00

(52) U.S. Cl. CPC G06N 20/00

(57) ABSTRACT

There is provided a technology capable of making an extremely accurate and precise response to an inquiry including a cross-cutting issue like the one which requires a plurality of pieces of business knowledge. A device for managing a plurality of machine learning models respectively having specializations in specified fields, wherein the device includes at least a processor and a storage device; the processor: accepts information about specialization related to an inquiry from a user; selects a machine learning model candidate which contributes to generation of response content for the inquiry, from the plurality of machine learning models in the list based on the specialization related to the inquiry, the specialization information, and the key word; and decides a machine learning model to be used for the generation of the response content for the inquiry based on the selected machine learning model candidate.

### CROSS-REFERENCE TO RELATED APPLICATION

The present application claims priority pursuant to 35 U.S.C. §119 from Japanese patent application no. 2025-025383 filed on February 19, 2025, the entire disclosure of which is hereby incorporated herein by reference.

### BACKGROUND

### Technical Field

The present invention relates to an information processing technology.

### Related Art

In recent years, the development of generative AI technology has been remarkable. In particular, on one hand, the generative AI technology using large-scale language models (hereinafter also referred to as “LLM”) has been rapidly applied to the processing of various natural language tasks in various fields, industries, workplaces, etc.

On the other hand, the generative AI technology using LLM has a problem of consuming a huge amount of electric power during computation due to high cost of learning models and large-scale computing resources required for inference.

In this context, a small language model(s) (hereinafter also referred to as “SLM(s)”), which has a small language model size and a small amount of computation required for inference, has recently attracted attention for applications that support various specific on-site operations such as manufacturing sites, maintenance sites, and law firms (for example, NPL1). This SLM can be utilized with limited resources and has such features that learning cost and power consumption of the model are smaller than those of LLM.

NON-PATENT LITERATURE (NPL) 1: arXiv:2308.08155

### SUMMARY OF THE INVENTION

SLM is very effective in solving specific problems such as on-site operations. On the other hand, a cross-cutting issue like the one which requires a plurality of pieces of business knowledge cannot be solved only by the single SLM.

The present invention was devised in light of the above-described problem and it is an object of the invention to provide a technology capable of making an extremely accurate and precise response to an inquiry including the cross-cutting issue like the one which requires the plurality of pieces of business knowledge.

An information processing device according to the present invention is a device for managing a plurality of machine learning models respectively having specializations in specified fields, wherein the information processing device includes at least a processor and a storage device; wherein the storage device stores: a list of the plurality of machine learning models which are management objects; specialization information about the respective specializations of the plurality of machine learning models; and a key word for extracting a machine learning model from the list; and wherein the processor: accepts information about specialization related to an inquiry from a user; selects a machine learning model candidate which contributes to generation of response content for the inquiry, from the plurality of machine learning models in the list based on the specialization related to the inquiry, the specialization information, and the key word; and decides a machine learning model to be used for the generation of the response content for the inquiry based on the selected machine learning model candidate.

If the present invention is employed, the extremely accurate and precise response can be made to the inquiry including the cross-cutting issue like the one which requires the plurality of pieces of business knowledge.

Other than the above, the problems and their solutions which are disclosed by this application will be clarified by the section of DESCRIPTION OF EMBODIMENTS and drawings.

### BRIEF DESCRIPTION OF THE DRAWINGS

FIG. 1 is a diagram illustrating an example of an overall configuration of a distributed AI system including an information processing device (coordinator SLM server) according to an embodiment;

FIG. 2 is a diagram illustrating an example of a hardware configuration of the coordinator SLM server and a specialized SLM server;

FIG. 3 is a diagram illustrating an example of functional blocks of the coordinator SLM server;

FIG. 4 is a diagram for explaining the outline of tokenization by a tokenization function unit;

FIG. 5 is a diagram illustrating an example of the configuration of a coordination database;

FIG. 6 is a diagram illustrating an example of the configuration of a specialized SLM search database;

FIG. 7 is a diagram illustrating an example of the configuration of a path management database;

FIG. 8 is a diagram illustrating an example of a node address database;

FIG. 9 is a diagram illustrating an example of functional blocks of the specialized SLM server;

FIG. 10 is a diagram illustrating an example of an SLM node address database;

FIG. 11 is a diagram illustrating an example of a use case for the distributed AI system;

FIG. 12 is a sequence diagram illustrating an example of a flow of processing executed by the distributed AI system in a case of FIG. 11; and

FIG. 13 is a diagram illustrating another example of an overall configuration of the distributed AI system.

### DETAILED DESCRIPTION OF THE INVENTION

Embodiments of the present invention will be described in detail with reference to the drawings. However, the present invention is not limited to the description content of the embodiments and variations indicated below. Examples whose specific configurations are changed are also included without departing from the idea or gist of the present invention. For example, the respective embodiments indicated below describe the present invention in detail and are not necessarily limited to those having all the configurations included in the descriptions.

In the configurations of the invention described below, the same reference numerals will be used in common between different drawings to indicate identical parts and/or elements or parts and/or elements having similar functions and any redundant explanations may sometimes be omitted.

Moreover, if there are a plurality of identical parts and/or elements or parts and/or elements having similar functions, different subscripts may sometimes be attached to the same reference numeral to distinguish between the plurality of parts and/or elements. On the other hand, if it is unnecessary to distinguish between the plurality of parts and/or elements, they may sometimes be described by omitting the subscripts.

Moreover, the expressions “first,” “second,” “third,” and so on in, for example, this description are attached to identify constituent elements and do not necessarily limit their quantity, sequential order, or content. Also, characters or numbers for identifying the constituent elements are used in each context; and the characters or numbers used in one context do not necessarily indicate the same configuration in other contexts. Furthermore, this does not preclude a constituent element identified with a certain character or number from also having functions of constituent elements identified with other characters or numbers.

Unless specifically clarified in the context, any constituent element indicated in a singular form in this description shall include its plural form.

Moreover, in the description indicated below, an “interface device” may be one or more interface devices. The one or more interface devices may be at least one of the following:

One or more input/output interface devices. The input/output interface is an interface device for at least one of an I/O (Input/Output) device and a remote display computer. The input/output interface for the display computer may be a network interface device. At least one I/O device may be a user interface device, for example, either one of input interface devices such as a keyboard and a pointing device, and output interface devices such as a display device.

One or more network interface devices. The one or more network interface devices may be one or more network interface devices of the same type (for example, one or more NICs [Network Interface Cards]) or two or more network interface devices of different types (for example, an NIC and an HBA [Host Bus Adapter]). Incidentally, for example, the Internet, a LAN (Local Area Network), a WAN (Wide Area Network), or a mobile phone network can be assumed as a network to be accessed by the communication interface upon communication, but the network is not limited to the above-mentioned examples.

Furthermore, in the description indicated below, a “storage device” includes at least one or more memory devices (hereinafter also referred to as a “memory”) as a main storage device. This memory may be a volatile memory device (hereinafter also referred to as a “volatile memory”) or may be a nonvolatile memory device (hereinafter also referred to as a “nonvolatile memory”). Furthermore, the storage device may include one or more PDEVs (Physical storage DEVices) as an auxiliary storage device(s) in addition to the one or more memories. This PDEV is typically a nonvolatile storage device (for example, a persistent storage device) and may specifically be, for example, various kinds of storage devices (hereinafter also referred to as “storage”) such as an HDD (Hard Disk Drive), an SSD (Solid State Drive), an NVME (Non-Volatile Memory Express) drive, or an SCM (Storage Class Memory).

Specifically speaking, in the description indicated below, the “storage device” may be at least the memory among the memory which is the main storage device and the storage which is the auxiliary storage device.

Furthermore, in the description indicated below, an “processor” which is an arithmetic device is one or more processor devices. At least one processor device is typically a microprocessor device like a CPU (Central Processing Unit), but may also include other types of processor device such as a GPU (Graphics Processing Unit), an MPU (Micro Processing Unit), or a DSP (Digital Signal Processor). At least one processor device may be single-core or multi-core. At least one processor device may be a processor core. At least one processor device may be a processor device in a broad sense such as a hardware circuit which performs part or all of processing (for example, FPGA [Field-Programmable Gate Array], CPLD [Complex Programmable Logic Device], or ASIC [Application Specific Integrated Circuit]), or may include such processor device(s) in the broad sense.

Furthermore, in the description indicated below, a function may be sometimes described by an expression like “xxx unit”; however, the function may be implemented by execution of one or more computer programs (hereinafter also simply referred to as a “program(s)”) by the processor, or may be implemented by one or more hardware circuits (such as FPGA or ASIC), or may be implemented by a combination of the above. If the function is implemented by the execution of a program by the processor, specified processing is performed by using, for example, storage devices and/or interface devices as appropriate and, therefore, the function may be considered as at least part of the processor. The processing explained by referring to the function as a subject may be the processing executed by the processor (or by a device like a controller which has that processor). The program may be installed from a program source. The program source may be, for example, a program distribution computer or a computer-readable recording medium (such as a non-transitory recording medium). An explanation of each function is one example, and a plurality of functions may be gathered as one function or one function may be divided into a plurality of functions.

Furthermore, in the description indicated below, there may be a case where processing will be explained by referring to a “program” as a subject; however, the program is executed by the processor to perform the defined processing by using the storage devices and/or the interface devices, etc., as appropriate, so the subject of the processing may be the processor (or a device like a controller having that processor). The program may be installed from a program source to a device such as a computer. The program source may be, for example, a program distribution server or a computer-readable recording medium (such as a non-transitory recording medium). Moreover, in the description indicated below, two or more programs may be implemented as one program or one program may be implemented as two or more programs.

Furthermore, in the following description, information which is obtained as outputs in response to inputs may be sometimes described by an expression like a “yyy database” or a “yyy table”; however, such information may be expressed by data of whatever structure (for example, either structured data or unstructured data) or may be a learning model represented by a neural network, a genetic algorithm, or a random forest which generates outputs in response to inputs. Therefore, the “yyy database” or the “yyy table” can be paraphrased as “yyy information.” Furthermore, in the description indicated below, the structure of each database or table is one example and one database or table may be divided into two or more databases or tables or all or some of two or more databases or tables may be one database or table.

Furthermore, in the description indicated below, a “data set(s)” means data composed of one or more data elements (one chunk of logical electronic data) and may be any one of, for example, a record(s), a file(s), a key value pair(s), and a tuple(s).

Furthermore, in the description indicated below, a “coordinator SLM server (information processing device)” or a “specialized SLM server” which constitutes a distributed AI system may be a device configured of one or more physical computers (such as an on-premise-type device) or may be a system (such as a cloud computing system) which is implemented on a physical calculation resource group (such as a cloud infrastructure). The distributed AI system “displaying” display information may be to display the display information on a display device possessed by a computer (the coordinator SLM server and/or the specialized SLM server) or may be for a computer (the coordinator SLM server and/or the specialized SLM server) to transmit the display information to a display computer (for example, a user terminal) (in the latter case, the display information is displayed by the display computer).

### SYSTEM CONFIGURATION EXAMPLE

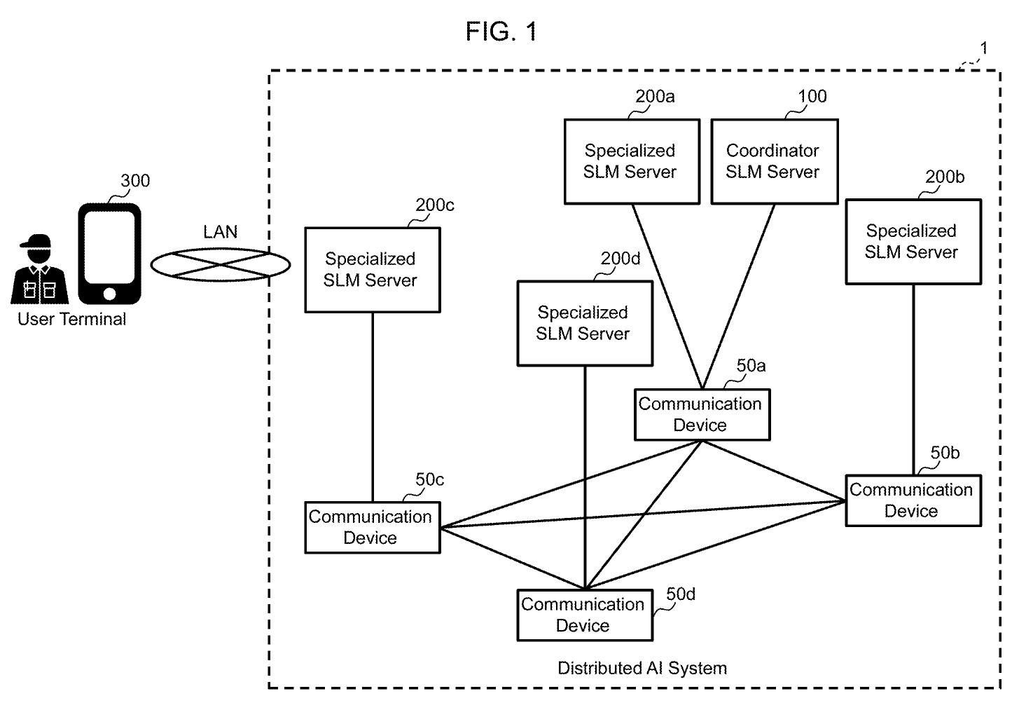

Firstly, a configuration example of a distributed AI system 1 according to this embodiment, and a coordinator SLM server 100 and a specialized SLM server 200, which are main constituent elements of the above-mentioned distributed AI system 1, will be explained below by using FIGS. 1 to 10.

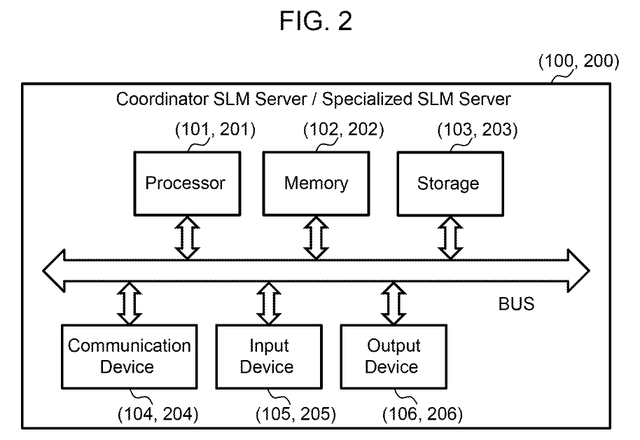

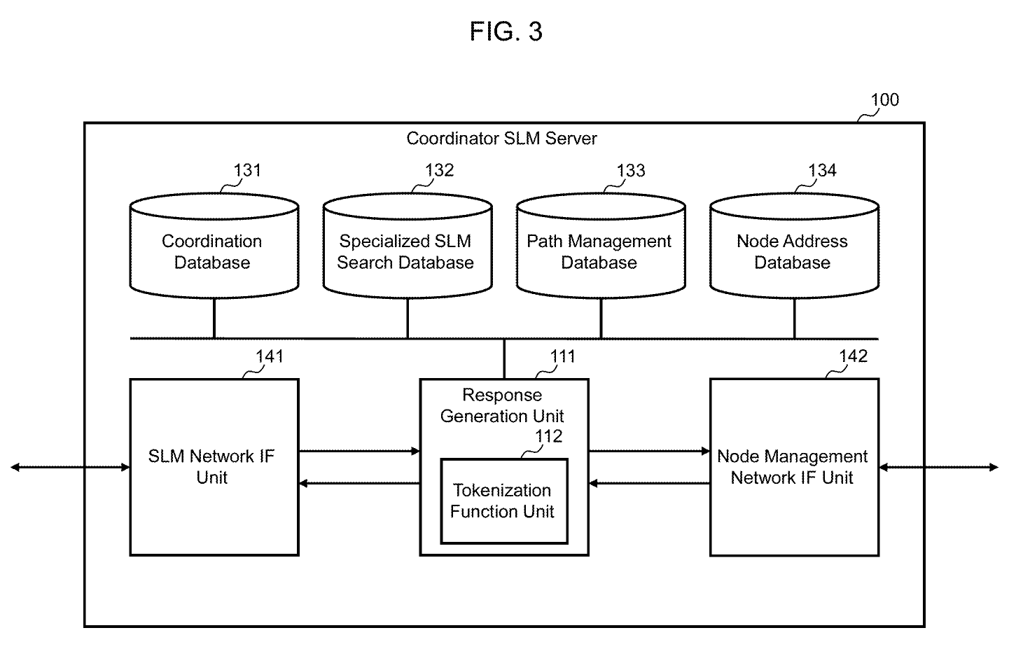

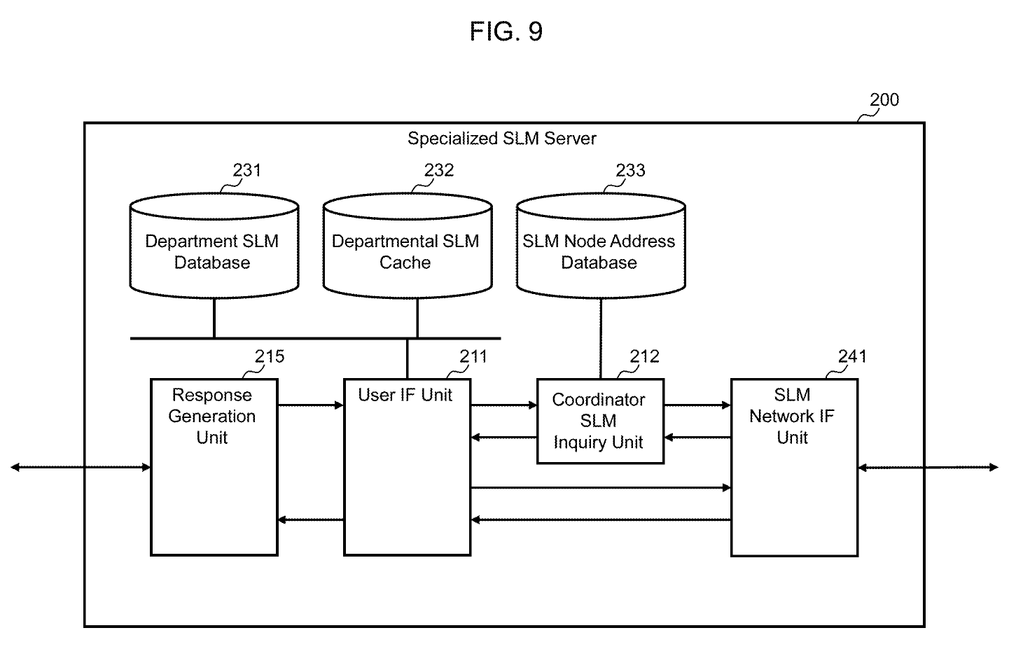

FIG. 1 is a diagram illustrating an example of the configuration of the entire system of the distributed AI system 1 including the coordinator SLM server 100 (information processing device). Moreover, FIG. 2 is a diagram illustrating an example of a hardware configuration of the coordinator SLM server 100 and the specialized SLM server 200 which are the major constituent elements of the distributed AI system 1. Furthermore, FIG. 3 is a diagram illustrating an example of functional blocks of the coordinator SLM server 100 and FIG. 9 is a diagram illustrating an example of functional blocks of the specialized SLM server 200, respectively.

### Configuration Example of the Entire System

The coordinator SLM server 100 of this embodiment schematically is, among computers which are installed at respective departments of the relevant company and operate SLMs (Small Language Models) which specialize in job details of the respective departments (hereinafter also referred to as “specialized SLM servers”) 200, a computer system capable of performing coordination with specialized SLM servers 200 used to solve problems, and is implemented by a server, a computer, or the like which is equipped with the respective configurations described later. This coordinator SLM server 100 is a general-purpose computer system which is physically composed of one computer or which is composed of a plurality of logically or physically configured computers, may operate in separate threads on the same computer, or may operate on a virtual computer which is constructed in a plurality of physical computer resources. In this embodiment, the coordinator SLM server 100 will be explained as being composed of one server; however, the coordinator SLM server 100 may be composed of, for example, a plurality of servers and/or computers.

At least each of the specialized SLM servers 200a, 200b, 200c, and so on up to 200n (hereinafter generally referred to as the “specialized SLM server 200” when they are mentioned collectively or when they are not distinguished from each other) which are installed at the respective departments of the relevant company are connected to this coordinator SLM server 100 via various kinds of communication devices and equipment (hereinafter simply generally referred to as a “communication device”) 50 as illustrated in FIG. 1 so that they can communicate data with each other. Specifically speaking, the coordinator SLM server 100 and the specialized SLM servers 200 are connected together by a communication network (hereinafter also simply referred to as a “network”) so that they can communicate data with each other.

Specifically speaking, the coordinator SLM server 100 and the specialized SLM servers 200 constitute the distributed AI system 1 illustrated by the example in FIG. 1 as a whole by being connected together via the communication device 50 so that they can communicate data with each other as described above.

Moreover, each of various kinds of user terminals 300 such as laptop PCs, tablets, and smartphones possessed by users of the distributed AI system 1 in a form including input devices and display devices, are connected via the network to each of the specialized SLM servers 200 and the coordinator SLM server 100 so that they can communicate data with each other as illustrated by the example in FIG. 1. Of these devices, the input devices are, for example, various kinds of input interface devices such as keyboards, pointing devices, and touch panels, for accepting input operations from the users of distributed AI system 1. Moreover, the display devices are, for example, various kinds of output interface devices, such as liquid crystal displays and touch screens, for outputting the processing results to the users of the distributed AI system 1 in a visually perceivable format. Incidentally, this embodiment will be explained that both the input device and the display device are operated integrally in a form serving an input function and an output function respectively in the same user terminal 300; however, the input device and the display device may be implemented, for example, as separate terminals. Moreover, each user terminal 300 and the network may be connected with each other wirelessly or by wire.

Moreover, for example, other equipment, devices, terminals, etc., such as various kinds of data servers (hereinafter simply referred to as “other devices”) may be further connected to the coordinator SLM server 100 and the specialized SLM servers 200 via the network. In this case, the other devices and the network may be connected by wire via the communication device 50 or may be connected wirelessly. Furthermore, in this case, the coordinator SLM server 100 and the specialized SLM servers 200 may acquire, for example, various kinds of data to be used for each processing described later from such other devices.

Incidentally, this embodiment has described that each of the coordinator SLM server 100 and the specialized SLM server 200 is composed of one computer as illustrated by the examples in FIGS. 1 to 4. However, for example, each of the coordinator SLM server 100 and the specialized SLM server 200 may be configured from a plurality of computers.

Furthermore, this embodiment has described that the coordinator SLM server 100 and the various kinds of equipment, devices, terminals, etc., such as the specialized SLM servers 200, the user terminals 300, and the other devices which are mutually connected to the coordinator SLM server 100 so that they can communicate data with each other (hereinafter sometimes generally referred to as “external devices”) are separate devices. However, the coordinator SLM server 100 and such external devices may be configured by, for example, the same device. In this case, the coordinator SLM server may be configured, for example, as a system including these external devices. Moreover, for example, the coordinator SLM server may be configured in a form including some or all of the functions served by these external devices.

### Hardware Configuration Eeample of Coordintor SLM Server 100

Next, an example of a hardware configuration of the coordinator SLM server 100 will be explained by using FIG. 2.

The coordinator SLM server 100 according to this embodiment is implemented by a storage device including a memory 102 which is a main storage device and a storage 103 which is an auxiliary storage device, an interface device including at least a communication device 104, and a processor 101 which is an arithmetic device connected to them. Moreover, in this coordinator SLM server 100, the interface device may include an input device 105 and/or an output device 106.

The following explanation will be provided by assuming that the coordinator SLM server 100 is implemented by one general-purpose computer device including one or more processors 101, one or more memories 102, one or more storages 3, one or more communication devices 104, one or more input devices 105, one or more output devices 106, and a wired or wireless BUS which connects them.

The storage 103, which is the auxiliary storage device, is an auxiliary storage device composed of a nonvolatile storage element such as a flash memory. Specific examples of this storage 103 can include various kinds of storages such as an SSD(s) (Solid State Drive(s)) and an HDD(s) (Hard Disk Drive(s)). The storage 3 stores at least an information processing program (which is not illustrated in the drawing). This information processing program is a computer program for implementing necessary functions as the coordinator SLM server 100.

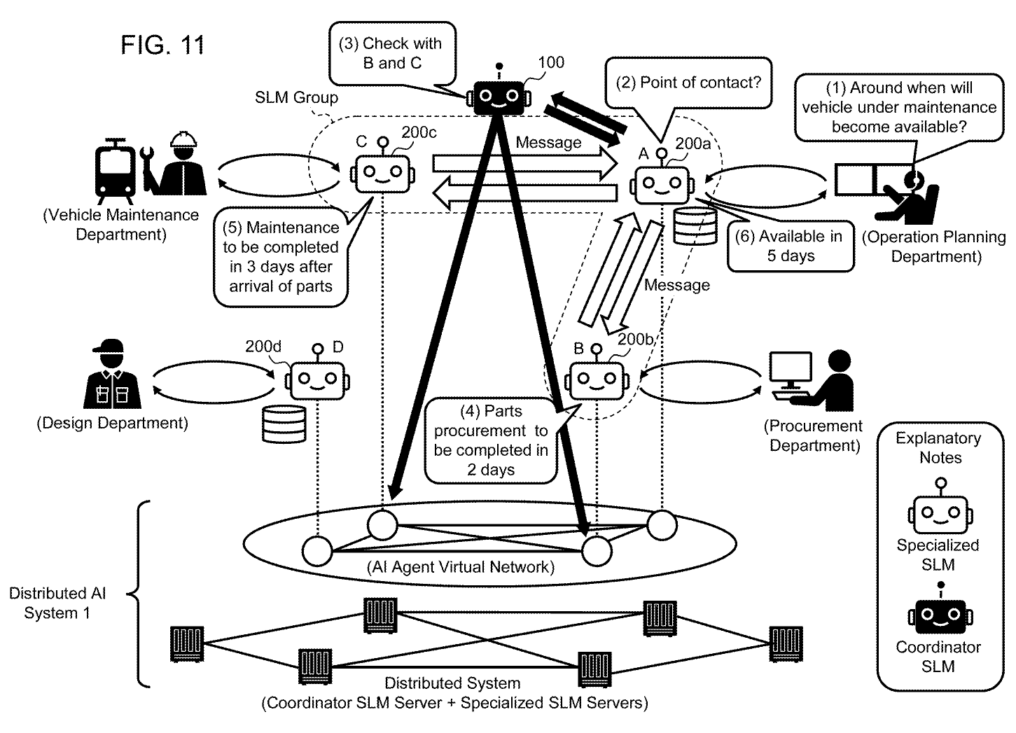

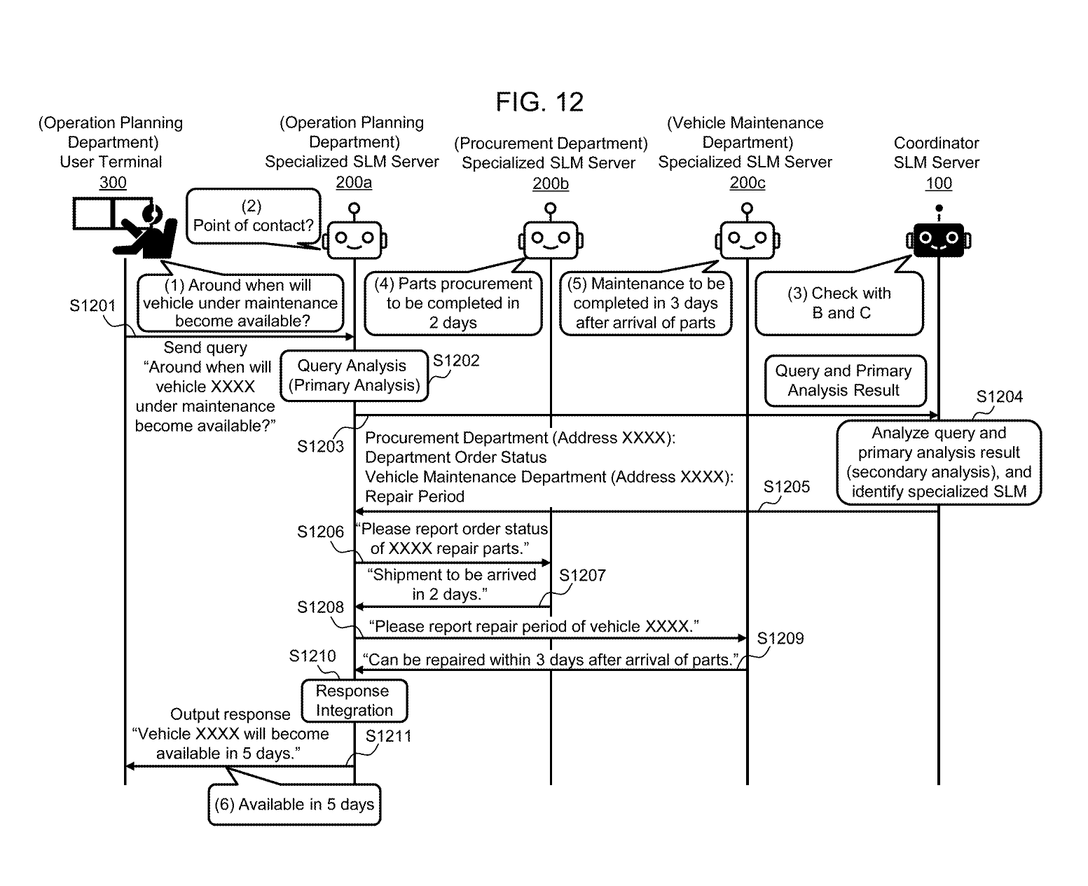

Specifically speaking, as the information processing program is executed by the processor 101, functions served by the respective function units possessed by the coordinator SLM server 100 such as a response generation unit 111 and a tokenization function unit 112 described later are implemented. In other words, various kinds of processing including the processing described later in relation to FIGS. 11 and 12 is performed by the execution of the information processing program by the processor 101.

Incidentally, the information processing program is provided to the coordinator SLM server 100 via the network and is stored in the storage 103 which is a non-transitory computer readable medium.

Moreover, the information processing program may be installed from a program source. The program source may be, for example, a program distribution computer or a computer-readable storage medium. Also, the information processing program may be configured of a device driver, an operating system, various kinds of application programs positioned in an upper layer of the above-mentioned device driver or operating system, or a library for providing these programs with shared functions. Furthermore, two or more programs may be implemented as one information processing program or one information processing program may be implemented as two or more programs.

The memory 102, which is the main storage device, is a main storage device mainly composed of a volatile storage element such as a RAM (Random Access Memory). Moreover, the memory 102 includes a ROM (Read Only Memory) which is composed of a nonvolatile storage element. The ROM stores, for example, immutable programs (for example, BIOS). This memory 102 temporarily retains data indicating various kinds of information read from the storage 103 and various kinds of data acquired via the communication device 104 and/or the input device 105.

The processor 101, which is the arithmetic device, is a processor device such as a CPU (Central Processing Unit) and various kinds of co-processors. This processor 101 serves as an arithmetic logic unit (which is not illustrated in the drawing) that has overall control of the coordinator SLM server 100 itself by invoking various kinds of computer programs including the information processing program to the memory 102 and executing them, and performs various kinds of processing for arithmetic operations, judgment, control, etc.

The interface device includes the communication device 104 which serves as a communication unit described later (which is not illustrated in the drawing), the input device 105 which serves as an input unit described later (which is not illustrated in the drawing), and the output device 106 which serves as an output unit described later (which is not illustrated in the drawing).

The communication device 104 is, for example, various kinds of network interface devices for controlling communication with the external devices, such as the specialized SLM servers 200 and the user terminals 300, according to a specified protocol.

The input device 105 is, for example, various kinds of input interface devices such as a touch panel, a keyboard, a mouse, a controller, etc., for accepting input operations from the user(s) of the distributed AI system 1 or an operator, etc., of the coordinator SLM server 100.

The output device 106 is, for example, various kinds of output interface devices including display devices such as a liquid crystal display, a touch display, etc., for outputting the processing results of the information processing program to the user(s) of the distributed AI system 1 and the operator, etc., of the coordinator SLM server 100 in a recognizable format.

Incidentally, the coordinator SLM server 100 may be implemented by an independent device or may be implemented by embedded equipment.

### Functional Block Example of Coordinator SLM Server 100

Next, an example of various kinds of functional blocks possessed by the coordinator SLM server 100 according to this embodiment will be explained by using FIG. 3. Incidentally, each block explained below indicates a function-based block, but not a hardware-based configuration.

The coordinator SLM server 100 is configured by including the respective functional blocks of the arithmetic logic unit (which is not illustrated in the drawing) mainly implemented by the aforementioned processor 101, the main storage unit (which is not illustrated in the drawing) implemented by the aforementioned memory 102, the auxiliary storage unit (which is not illustrated in the drawing) implemented by the aforementioned storage 103, the communication unit (which is not illustrated in the drawing) implemented by the aforementioned communication device 104, and the user interface unit (which is not illustrated in the drawing) including the input unit (which is not illustrated in the drawing) implemented by the aforementioned input device 105 and the output unit (which is not illustrated in the drawing) implemented by the aforementioned output device 106. Incidentally, in the following explanation, the main storage unit and the auxiliary storage unit will be sometimes collectively referred to as a storage unit.

The arithmetic logic unit executes various kinds of data processing based on programs and data stored in the storage unit, and data acquired by the communication unit. The arithmetic logic unit also functions as an interface for the storage unit and the communication unit.

The arithmetic logic unit has at least the respective functional blocks of the response generation unit 111 and the tokenization function unit 112 by the execution of the aforementioned information processing program by the processor 101.

The response generation unit 111 executes processing for generating at least response sentences to various kinds of inputs such as queries representing question sentences which are input by the user(s) of the distributed AI system 1.

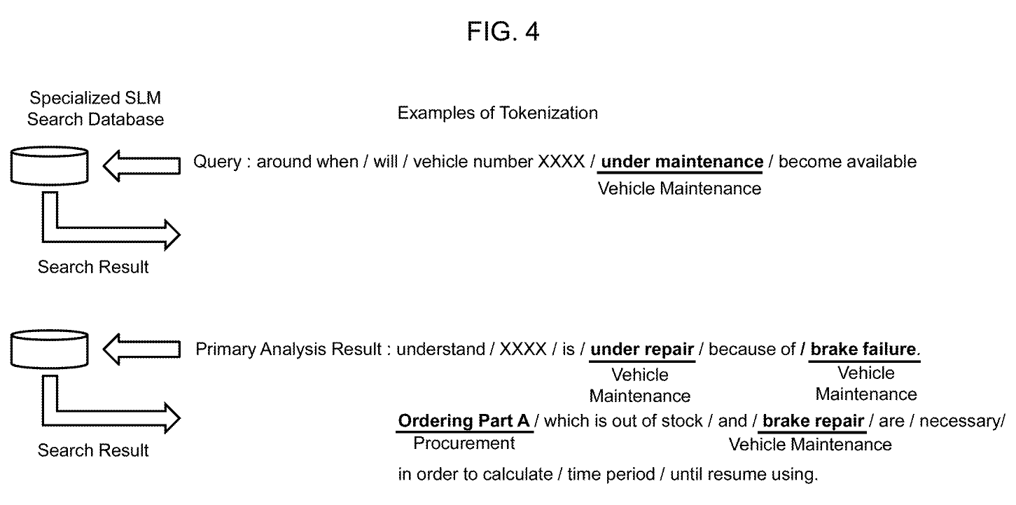

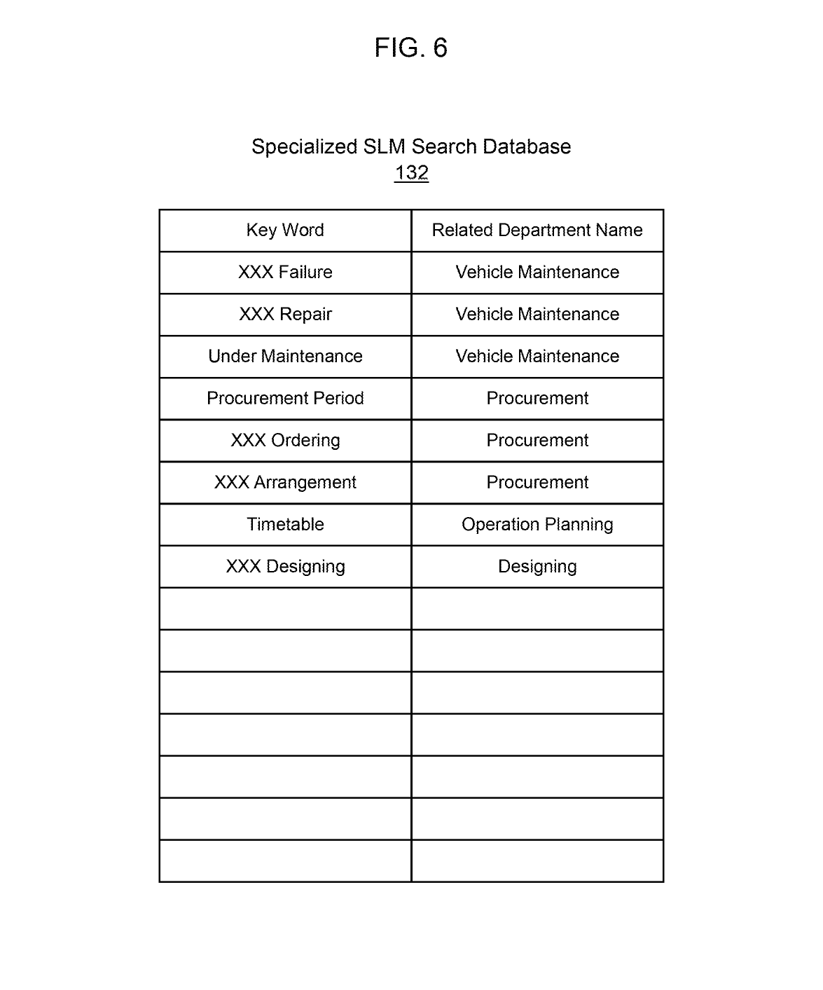

The tokenization function unit 112 executes at least processing relating to tokenization of a query indicating a question sentence regarding which the user of the distributed AI system 1 has performed an input operation, and the result of analysis (hereinafter also referred to as a “primary analysis”) processing regarding the query (hereinafter also referred to as a “primary analysis result”), and so on. In conventional generative AI techniques using language models, the tokenization is performed mainly to generate a response sentence. On the other hand, with the coordinator SLM server 100 according to this embodiment, individual tokens obtained as a result of the tokenization performed by the tokenization function unit 112 are registered as key words in a specialized SLM search database 132 (its details will be described later in relation to FIG. 6), so that such tokenization is also used, in addition to the generation of the response sentence, for a response to an inquiry indicated by the relevant query and for the coordination of the specialized SLM servers 200 to be used to solve a problem contained in the content of the relevant inquiry. Incidentally, this tokenization by the tokenization function unit 112 is performed, for example, in a manner illustrated in FIG. 4.

The arithmetic logic unit is configured by using the processor 101 which is the arithmetic device, and can implement these functional blocks by executing the aforementioned information processing program. Incidentally, the arithmetic logic unit may be configured by using, instead of the processor 101, for example, a logic circuit such as an FPGA (Field Programmable Gate Array) and an ASIC (Application Specific Integrated Circuit). Also, the arithmetic logic unit may be configured by a combination of the processor 101 and the logic circuit.

The storage unit is configured as described earlier by including the main storage unit implemented by the memory 102 which is the main storage device, and the auxiliary storage unit implemented by the storage 103 which is the auxiliary storage device, and stores programs for supplying various kinds of processing instructions to the arithmetic logic unit and data indicating various kinds of information to be used in the processing executed by the arithmetic logic unit.

The storage unit stores a coordination database 131 and the specialized SLM search database 132 as illustrated by the example in FIG. 3.

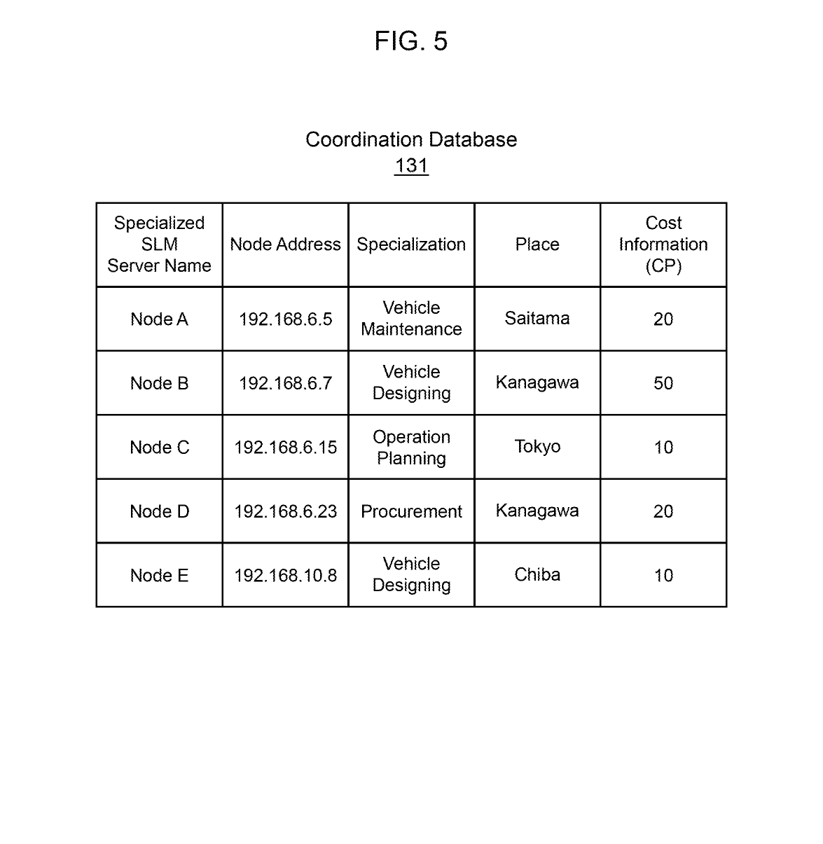

The coordination database 131 is a database for managing various kinds of information about the coordination of the specialized SLM servers 200. FIG. 5 shows an example of the configuration of this coordination database 131. The coordination database 131 has a record for each name of a specialized SLM server 200 which is a target of the coordination (hereinafter also referred to as a “specialized SLM server name”). A record indicates at least, for example, the specialized SLM server name which is the coordination target, the address of a node in the network where the specialized SLM server 200 identified by the above-mentioned specialized SLM server name (hereinafter also referred to as a “node address”), specialization of the relevant specialized SLM server 200, and a place where the specialized SLM server 200 is installed. Moreover, the record may also include, for example, as illustrated in FIG. 5, cost information that is an index indicating required cost to use the relevant specialized SLM server 200 as an option. Specifically speaking, the coordination database 131 is designed to manage the specialized SLM servers 200 which are targets of the coordination with respect to each specialized SLM server name by linking and recording, in each record, the specialized SLM server name, the node address of the specialized SLM server 200 identified by that specialized SLM server name, the specialization, the installed place, and the cost information. It is recorded in the coordination database 131 according to the example illustrated in FIG. 5 that the specialized SLM server 200 which is identified by the specialized SLM server name “Node A” and whose node address is “192.168.6.5” specializes in the “vehicle maintenance” and is installed in “Saitama,” and its cost information is “20.”

The specialized SLM search database 132 is a database for making a list of key words which are assumed to be used when searching for the specialized SLM server 200 for the purpose of the coordination, thereby managing the key words. FIG. 6 shows an example of the configuration of this specialized SLM search database 132. The specialized SLM search database 132 has a record for each key word. A record indicates, for example, a key word which may possibly be used when searching for the specialized SLM server 200, and a related department name indicating the name of a department having a correspondence relationship with the relevant key word. Incidentally, regarding the key words registered in the specialized SLM search database 132, some or all of them may be the tokens obtained by the tokenization performed by the tokenization function unit 112 or may include the tokens. Specifically speaking, the specialized SLM search database 132 is designed to manage the name of the department where the specialized SLM server 200 which should be the coordination target is installed, with respect to each key word when the search for the specialized SLM server 200 is performed by using the key word, by linking and recording, in each record, a key word and the related department name of that key word. It is recorded in the specialized SLM search database 132 according to the example illustrated in FIG. 6 that when the search for the specialized SLM server 200 is performed with the key word “XXX failure (for example, a “brake failure”),” the specialized SLM server 200 at the vehicle maintenance department should be the coordination target.

Furthermore, the storage unit may store a path management database 133 and a node address database 134 as illustrated by the example in FIG. 3.

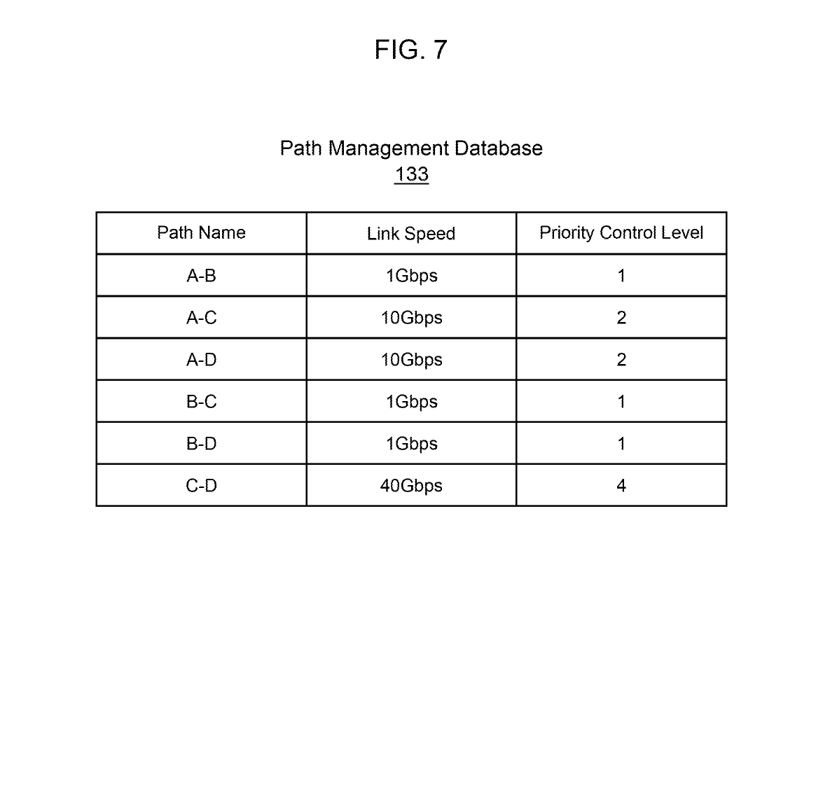

The path management database 133 is a table for mainly managing a communication path between the coordinator SLM server 100 and the individual specialized SLM servers 200 or the communication path used when communicating data between the specialized SLM servers 200 (hereinafter also simply referred to as a “path”). FIG. 7 shows an example of the configuration of this path management database 133. The path management database 133 has a record with respect to each name for uniquely identifying a path connecting two different nodes (hereinafter also referred to as a “path name”). A record indicates, for example, a path name, a link speed indicating an average speed of data communication performed in the path indicated by the above-mentioned path name, and a priority control level indicating a priority level of the data communication performed in the relevant path. Specifically speaking, the path management database 133 is designed to manage the link speed and the priority control level of the data communication performed between two different nodes by linking and recording, in each record, the path name and the link speed and the priority control level of the data communication performed in the path identified by the above-mentioned path name. It is recorded in the path management database 133 according to the example illustrated in FIG. 7 that regarding the data communication performed in the path identified by the path name, the link speed is “1 Gbps” and the priority control level is “1.”

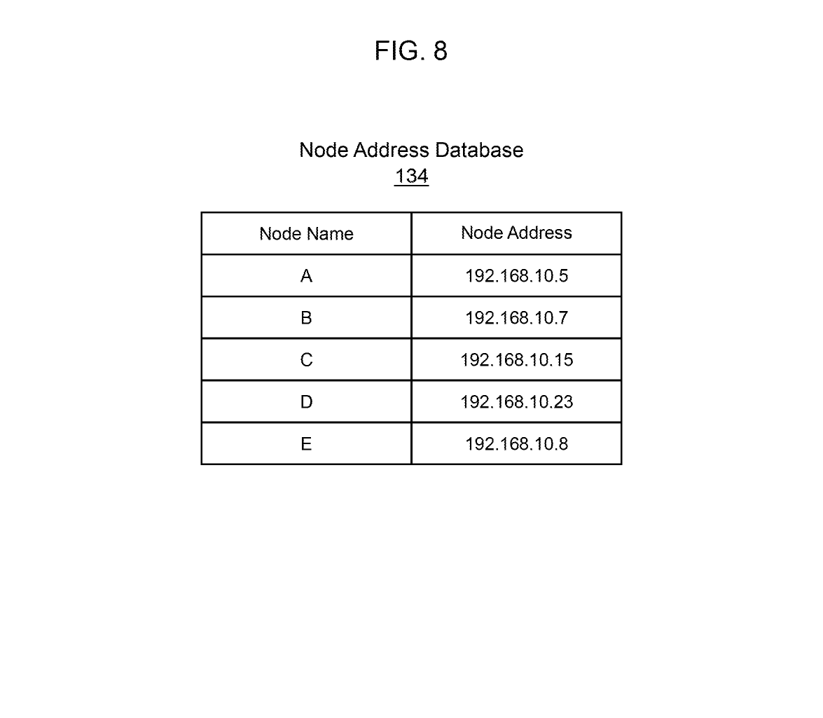

The node address database 134 is a table for managing the name of a node where the coordinator SLM server 100 or the individual specialized SLM server 200 is installed (hereinafter also referred to as a “node name”) and its address (hereinafter also referred to as a “node address”). FIG. 8 shows an example of the configuration of this node address database 134. The node address database 134 has a record for each node name. A record indicates, for example, a node name and the address of a node indicated by the above-mentioned node name. Specifically speaking, the node address database 134 is designed to manage the name and address of each node with respect to each node by linking and recording, in each record, the node name and the node address. It is recorded in the node address database 134 according to the example illustrated in FIG. 8 that the address of the node with the name “A” is “192.168.10.5.”

The arithmetic logic unit can execute various kinds of processing by reading and writing data indicating these pieces of information from and to the storage unit.

The communication unit is in charge of processing for communicating with the external devices such as the specialized SLM server 200 and the user terminal 300 via the network. The communication unit is configured by using, for example, an NIC (Network Interface Card), an HBA (Host Bus Adapter), etc.

The communication unit has an SLM network interface unit 141 as a functional block.

The SLM network interface unit 141 is in charge of processing for communicating with the specialized SLM server 200. Incidentally, for example, when making an inquiry to a specialized SLM server 200 which is a coordination target, the SLM network interface unit 141 can impose a limitation so as not to cause any useless inquiry to occur by making inquiries in good order as necessary without mesh-connecting the specialized SLM server 200.

Furthermore, the communication unit may have a node management network interface unit 142 as a functional block.

The node management network interface unit 142 is in charge of processing relating to node management.

The user interface unit is configured by including the respective functional blocks of the input unit and the output unit.

Of the processing relating to the user interface, the input unit is in charge of processing relating to inputs such as accepting input operations from the user. The input unit is configured by using various kinds of input devices 105 such as a touch panel, a keyboard, a mouse, and a controller and detects various kinds of operations from the user.

Of the processing relating to the user interface, the output unit is in charge of processing relating to outputs such as displaying of various kinds of screens on the output device 106 and audio outputs to the output device 106. The output unit is configured by using various kinds of output devices 106 including display devices such as a touch screen and a liquid crystal display.

Incidentally, for example, when another equipment such as a tablet, a smartphone, a laptop PC, etc., remotely logs into the coordinator SLM server 100, or when the coordinator SLM server 100 accepts input information from the external devices via the communication device 104, or when the coordinator SLM server 100 supplies output information to the external devices, it is not required to be equipped with the input unit and/or the output unit. In this case, the coordinator SLM server 100 may accept access from the external devices according to a specified protocol.

Specifically speaking, the respective constituent elements of the coordinator SLM server 100 are implemented by hardware including the processor 101 which is the arithmetic device, the storage device such as the memory 102 which is the main storage device and the storage 103 which is the auxiliary storage device, the interface device such as the communication device 104, the input device 105, and the output device 106, and a wired or wireless BUS for connecting the above-listed devices, and by software which is stored in the storage device (102, 103) and supplies processing instructions to the arithmetic unit (the processor 101).

The above-mentioned explanation about the functions of the coordinator SLM server 100 has been made by assuming that the respective functions of the coordinator SLM server 100 are implemented integrally by one computer. However, these respective functions may be implemented by a plurality of computers and/or servers which are connected to each other. Moreover, the coordinator SLM server 100 may be configured by including various kinds of mobile equipment.

In the coordinator SLM server 100, the respective function units such as the response generation unit 111 and the tokenization function unit 112 may be designed to operate, for example, respectively in separate physical or logical computers or the plurality of the function units 112 may be combined to operate in one physical or logical computer.

Furthermore, the above explanation about the respective functions is one example and a plurality of functions may be gathered as one function or one function may be divided into a plurality of functions.

Furthermore, the coordinator SLM server 100 may further have other functions in addition to the above-described respective functions. For example, the coordinator SLM server 100 may be configured in a form including some or all of the various kinds of functions possessed by the external devices such as the specialized SLM server 200 and the user terminal 300.

### Hardware Configuration Example of Specialized SLM Server 200

Next, an explanation will be provided about a hardware configuration of the specialized SLM server 200 by using FIG. 2.

The specialized SLM server 200 according to this embodiment is implemented by a computer having at least a storage device including a memory 202 which is a main storage device and a storage 203 which is an auxiliary storage device, an interface device at least including a communication device 204, and a processor 201 which is an arithmetic device connected to these above-described devices. Moreover, in this specialized SLM server 200, the interface device may include an input device 205 and/or an output device 206.

The following explanation will be provided by assuming that the specialized SLM server 200 is implemented by one general-purpose computer device including one or more processors 201, one or more memories 202, one or more storages 203, one or more communication devices 204, one or more input devices 205, one or more output devices 206, and a wired or wireless BUS which connects them.

The storage 203, which is the auxiliary storage device, is an auxiliary storage device composed of a nonvolatile storage element such as a flash memory. Specific examples of this storage 203 can include various kinds of storages such as an SSD(s) (Solid State Drive(s)) and an HDD(s) (Hard Disk Drive(s)). The storage 203 stores at least an information processing program. This information processing program is a computer program for implementing necessary functions as the specialized SLM server 200.

Specifically speaking, as the information processing program is executed by the processor 201, functions served by the respective function units possessed by the specialized SLM server 200 such as a response generation unit 211 and a coordinator SLM inquiry unit 212 described later are implemented. In other words, various kinds of processing including the processing described later in relation to FIGS. 11 and 12 is performed by the execution of the information processing program by the processor 201.

Incidentally, the information processing program is provided to the specialized SLM server 200 via the network and is stored in the storage 203 which is a non-transitory computer readable medium.

Moreover, the information processing program may be installed from a program source. The program source may be, for example, a program distribution computer or a computer-readable storage medium. Also, the information processing program may be configured of a device driver, an operating system, various kinds of application programs positioned in an upper layer of the above-mentioned device driver or operating system, or a library for providing these programs with shared functions. Furthermore, two or more programs may be implemented as one information processing program or one information processing program may be implemented as two or more programs.

The memory 202, which is the main storage device, is a main storage device mainly composed of a volatile storage element such as a RAM (Random Access Memory). Moreover, the memory 202 includes a ROM (Read Only Memory) which is composed of a nonvolatile storage element. The ROM stores, for example, immutable programs (for example, BIOS). This memory 202 temporarily retains data indicating various kinds of information read from the storage 203 and various kinds of data acquired via the communication device 204 and/or the input device 205.

The processor 201, which is the arithmetic device, is a processor device such as a CPU (Central Processing Unit) and various kinds of co-processors. This processor 201 serves as an arithmetic logic unit (which is not illustrated in the drawing) that has overall control of the specialized SLM server 200 itself by invoking various kinds of computer programs including the information processing program to the memory 202 and executing them, and performs various kinds of processing for arithmetic operations, judgment, control, etc.

The interface device includes the communication device 204 which serves as a communication unit described later (which is not illustrated in the drawing), the input device 205 which serves as an input unit described later (which is not illustrated in the drawing), and the output device 206 which serves as an output unit described later (which is not illustrated in the drawing).

The communication device 204 is, for example, various kinds of network interface devices for controlling communication with the external devices, such as the specialized SLM servers 200 and the user terminals 300, according to a specified protocol.

The input device 205 is, for example, various kinds of input interface devices such as a touch panel, a keyboard, a mouse, a controller, etc., for accepting input operations from the user(s) of the distributed AI system 1 or an operator, etc., of the specialized SLM server 200.

The output device 206 is, for example, various kinds of output interface devices including display devices such as a liquid crystal display, a touch display, etc., for outputting the processing results of the information processing program to the user(s) of the distributed AI system 1 and the operator, etc., of the specialized SLM server 200 in a recognizable format.

Incidentally, the specialized SLM server 200 may be implemented by an independent device or may be implemented by embedded equipment.

### Functional Block Example of Specialized SLM Server 200

Next, an example of various kinds of functional blocks possessed by the specialized SLM server 200 according to this embodiment will be explained by using FIG. 9. Incidentally, each block explained below indicates a function-based block, but not a hardware-based configuration.

The specialized SLM server 200 is configured by including the respective functional blocks of the arithmetic logic unit (which is not illustrated in the drawing) mainly implemented by the aforementioned processor 201, the main storage unit (which is not illustrated in the drawing) implemented by the aforementioned memory 202, the auxiliary storage unit (which is not illustrated in the drawing) implemented by the aforementioned storage 203, the communication unit (which is not illustrated in the drawing) implemented by the aforementioned communication device 204, and the user interface unit 215 including the input unit (which is not illustrated in the drawing) implemented by the aforementioned input device 205 and the output unit (which is not illustrated in the drawing) implemented by the aforementioned output device 206. Incidentally, in the following explanation, the main storage unit and the auxiliary storage unit will be sometimes collectively referred to as a storage unit.

The arithmetic logic unit executes various kinds of data processing based on programs and data stored in the storage unit, and data acquired by the communication unit. The arithmetic logic unit also functions as an interface for the storage unit and the communication unit.

The arithmetic logic unit has at least the respective functional blocks of the response generation unit 211 and the coordinator SLM inquiry unit 212 by the execution of the aforementioned information processing program by the processor 201.

The response generation unit 211 executes at least processing for generating responses.

The coordinator SLM inquiry unit 212 executes at least processing relating to inquiries to the coordinator SLM server 100.

The arithmetic logic unit is configured by using the processor 201 which is the arithmetic device, and can implement these functional blocks by executing the aforementioned information processing program. Incidentally, the arithmetic logic unit may be configured by using, instead of the processor 201, for example, a logic circuit such as an FPGA (Field Programmable Gate Array) and an ASIC (Application Specific Integrated Circuit). Also, the arithmetic logic unit may be configured by a combination of the processor 201 and the logic circuit.

The storage unit is configured as described earlier by including the main storage unit implemented by the memory 202 which is the main storage device, and the auxiliary storage unit implemented by the storage 203 which is the auxiliary storage device, and stores programs for supplying various kinds of processing instructions to the arithmetic logic unit and data indicating various kinds of information to be used in the processing executed by the arithmetic logic unit.

The storage unit stores at least a department SLM database 231, a departmental SLM cache 232, and an SLM node address database 233 as illustrated by the example in FIG. 9.

The department SLM database 231 is a database for managing a specialized SLM that is a language model which is implemented by the relevant specialized SLM server 200 and which specializes in the job details of a department where the relevant specialized SLM server 200 is installed.

The departmental SLM cache 232 stores a cache associated with the processing of the relevant specialized SLM.

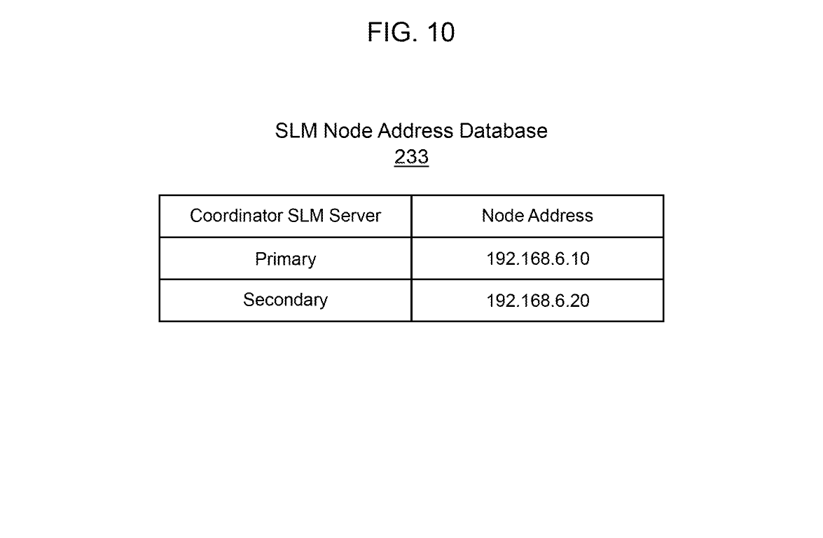

The SLM node address database 233 is a database for managing a node address designated when the relevant specialized SLM server 200 connects to the coordinator SLM server 100. FIG. 10 shows an example of the configuration of this SLM node address database 233. The SLM node address database 233 has a record for the name of each connection channel designated when the relevant specialized SLM server 200 connects to the coordinator SLM server 100 (hereinafter also referred to as a “channel name”). A record shows, for example, the channel name designated when connecting to the coordinator SLM server 100, and a node address having a correspondence relationship with that channel name. Specifically speaking, the node address database 134 is designed to manage the node address, which is designated when the relevant specialized SLM server 200 connects to the coordinator SLM server 100, with respect to each connection channel by linking and recording the channel name and the node address in each record. It is recorded in the SLM node address database 233 according to the example illustrated in FIG. 10 that when the connection channel used when the relevant specialized SLM server 200 connects to the coordinator SLM server 100 is “primary,” the designated node address is “192.168.6.10.”

The arithmetic logic unit can execute various kinds of processing by reading and writing data indicating these pieces of information from and to the storage unit.

The communication unit is in charge of processing for communicating with the external devices such as the coordinator SLM server 100 and the user terminal 300 via the network. The communication unit is configured by using, for example, an NIC (Network Interface Card), an HBA (Host Bus Adapter), etc.

The communication unit has an SLM network interface unit 241 as a functional block.

The SLM network interface unit 241 is in charge of processing for communicating with the coordinator SLM server 100.

The user interface unit 215 is configured by including the respective functional blocks of the input unit and the output unit.

Of the processing relating to the user interface, the input unit is in charge of processing relating to inputs such as accepting input operations from the user. The input unit is configured by using various kinds of input devices 205 such as a touch panel, a keyboard, a mouse, and a controller and detects various kinds of operations from the user.

Of the processing relating to the user interface, the output unit is in charge of processing relating to outputs such as displaying of various kinds of screens on the output device 206 and audio outputs to the output device 206. The output unit is configured by using various kinds of output devices 206 including display devices such as a touch screen and a liquid crystal display.

Incidentally, for example, when another equipment such as a tablet, a smartphone, a laptop PC, etc., remotely logs into the specialized SLM server 200, or when the specialized SLM server 200 accepts input information from the external devices via the communication device 204, or when the specialized SLM server 200 supplies output information to the external devices, it is not required to be equipped with the input unit and/or the output unit. In this case, the specialized SLM server 200 may accept access from the external devices according to a specified protocol.

Specifically speaking, the respective constituent elements of the specialized SLM server 200 are implemented by hardware including the processor 201 which is the arithmetic device, the storage device such as the memory 202 which is the main storage device and the storage 203 which is the auxiliary storage device, the interface device such as the communication device 204, the input device 205, and the output device 206, and a wired or wireless BUS for connecting the above-listed devices, and by software which is stored in the storage device (202, 203) and supplies processing instructions to the arithmetic unit (the processor 201).

The above-mentioned explanation about the functions of the specialized SLM server 200 has been made by assuming that the respective functions of the specialized SLM server 200 are implemented integrally by one computer. However, these respective functions may be implemented by a plurality of computers and/or servers which are connected to each other. Moreover, the specialized SLM server 200 may be configured by including various kinds of mobile equipment.

In the specialized SLM server 200, the respective function units such as the response generation unit 211 and the coordinator SLM inquiry unit 212 may be designed to operate, for example, respectively in separate physical or logical computers or the plurality of the function units may be combined to operate in one physical or logical computer.

Furthermore, the above explanation about the respective functions is one example and a plurality of functions may be gathered as one function or one function may be divided into a plurality of functions.

Furthermore, the specialized SLM server 200 may further have other functions in addition to the above-described respective functions. For example, the specialized SLM server 200 may be configured in a form including some or all of the various kinds of functions possessed by the external devices such as the coordinator SLM server 100 and the user terminal 300.

### SYSTEM OPERATION EXAMPLES

Next, an example of operations of the coordinator SLM server 100 and the specialized SLM server 200 described above in the distributed AI system 1 according to this embodiment will be explained by using FIGS. 11 and 12.

FIG. 11 is a diagram illustrating an example of operations of the distributed AI system 1 including, as constituent elements, the coordinator SLM server 100, a specialized SLM server 200a of an operation planning department, a specialized SLM server 200b of a procurement department, and a specialized SLM server 200c of a vehicle maintenance department as a use case of the distributed AI system 1. Moreover, FIG. 12 is a sequence diagram illustrating an example of a flow of the processing executed by the distributed AI system 1 in the case of FIG. 11.

Both FIGS. 11 and 12 illustrate an example of the operations of the distributed AI system 1 where a user of the distributed AI system 1 who belongs to an operation planning department of a railroad company performs an input operation to input a prompt including a cross-cutting issue like the one which requires a plurality of pieces of business knowledge, for example, “When a vehicle XXXX under maintenance will become available?” to a user terminal 300 possessed by the user (hereinafter also referred to as the “user terminal 300 of the operation planning department”) (see (1) in FIGS. 11 to 12).

After accepting the input operation of the above-described prompt from the user, the arithmetic logic unit for the user terminal 300 of the operation planning department executes processing for transmitting a query indicating the content of the prompt to the specialized SLM server 200a of the operation planning department (step S1201 in FIG. 12). Consequently, that query is transmitted to the specialized SLM server 200a of the operation planning department.

After receiving this query from the user terminal 300 via the communication unit, the arithmetic logic unit for the specialized SLM server 200a of the operation planning department performs an analysis of the query (primary analysis) (step S1202 in FIG. 12). Consequently, the primary analysis of the query is performed.

When the primary analysis of the query is completed, the arithmetic logic unit for the specialized SLM server 200a of the operation planning department executes processing for transmitting the query and the result of the primary analysis performed regarding the query to the coordinator SLM server 100 (step S1203 in FIG. 12). Moreover, when this happens, the arithmetic logic unit for the specialized SLM server 200a of the operation planning department causes the response generation unit 211a to ask a question “A point of contact?” to the coordinator SLM server 100 (see (2) in FIGS. 11 and 12). Consequently, the query and the result of the primary analysis as well as that question are transmitted to the coordinator SLM server 100.

After receiving the query and the result of the primary analysis as well as the question from the specialized SLM server 200a of the operation planning department, the arithmetic logic unit for the coordinator SLM server 100 performs an analysis of the query and the result of the primary analysis (secondary analysis) and identifies, based on the result of this secondary analysis, specialized SLM servers 200 to which an inquiry for the coordination should be made, their affiliations indicating where the relevant specialized SLM servers 200 belong, and an item(s) regarding which the inquiry is to be made to the specialized SLM servers 200 (hereinafter also referred to as a “check item(s)”) (step S1204 in FIG. 12). Consequently, the secondary analysis of the query and the result of the primary analysis is performed and the specialized SLM servers 200 to which the inquiry for the coordination should be made, as well as their affiliations and the check items, are identified based on the result of the secondary analysis. In the case of the example illustrated by FIGS. 11 and 12, the specialized SLM servers 200 which should be targets of the inquiry are the specialized SLM server 200b of the procurement department and the specialized SLM server 200c of the vehicle maintenance department and the check item for the specialized SLM server 200b of the procurement department is a parts order status and the check item for the specialized SLM server 200c of the vehicle maintenance department is a repair period.

The arithmetic logic unit for the coordinator SLM server 100 performs the secondary analysis of the query and the result of the primary analysis and identifies the specialized SLM servers 200 to which the inquiry for the coordination should be made, as well as their affiliations and the check items, based on the result of the secondary analysis, and it transmits the identified content to the specialized SLM server 200a of the operation planning department (step S1205 in FIG. 12). Consequently, these items identified in step S1204 in FIG. 12 are transmitted to the specialized SLM server 200a of the operation planning department. In the case illustrated by the example in FIGS. 11 and 12, the response generation unit 111 is caused to transmit that the specialized SLM servers 200 which should become the inquiry targets are the specialized SLM server 200b of the procurement department and the specialized SLM server 200c of the vehicle maintenance department (see (3) in FIGS. 11 and 12), the check item for the specialized SLM server 200b of the procurement department is the parts order status, and the check item for the specialized SLM server 200c of the vehicle maintenance department is the repair period.

After receiving the above-mentioned items identified in step S1204 in FIG. 12 from the coordinator SLM server 100, the arithmetic logic unit for the specialized SLM server 200a of the operation planning department causes the response generation unit 211a to firstly make an inquiry to the specialized SLM server 200b of the procurement department about the order status of the parts required to repair the relevant vehicle, which is the item positioned relatively upstream in order to estimate the “time when the vehicle XXXX under maintenance becomes available” (step S1206 in FIG. 12). Consequently, the inquiry about the order status of the parts is made to the specialized SLM server 200b of the procurement department.

After receiving the inquiry about the parts order status from the specialized SLM server 200a of the operation planning department, the arithmetic logic unit for the specialized SLM server 200b of the procurement department estimates an amount of time required to procure the relevant parts by using the relevant specialized SLM and causes the response generation unit 211b to send the estimation result as a response to the specialized SLM server 200a of the operation planning department (step S1207 in FIG. 12). In the case illustrated by the example in FIGS. 11 and 12, the response generation unit 211b is caused to send the response to inform the specialized SLM server 200a of the operation planning department that the relevant parts can be procured in two days (see (4) in FIGS. 11 and 12). Consequently, the response is made precisely to the inquiry made by the specialized SLM server 200a of the operation planning department in step S1206 in FIG. 12.

After accepting the above-described response from the specialized SLM server 200b of the procurement department in step S1207 in FIG. 12, the arithmetic logic unit for the specialized SLM server 200a of the operation planning department then causes the response generation unit 211a to send an inquiry to the specialized SLM server 200c of the vehicle maintenance department about a required time period to repair the relevant vehicle, which is the item positioned relatively downstream in order to estimate the “time when the vehicle XXXX under maintenance becomes available” (step S1208 in FIG. 12). Consequently, the inquiry about the required time period to repair the relevant vehicle is made to the specialized SLM server 200c of the vehicle maintenance department.

After receiving the inquiry about the required time period to repair the relevant vehicle from the specialized SLM server 200a of the operation planning department, the arithmetic logic unit for the specialized SLM server 200c of the vehicle maintenance department estimates the required amount of time to repair the relevant vehicle by using the relevant specialized SLM and causes the response generation unit 211c to send the estimation results as a response to the specialized SLM server 200a of the operation planning department (step S1209 in FIG. 12). In the case illustrated by the example in FIGS. 11 and 12, the response generation unit 211c is caused to send the response to inform the specialized SLM server 200a of the operation planning department that the repair of the relevant vehicle will be completed within three days after the arrival of the relevant parts (see (5) in FIGS. 11 and 12). Consequently, the response to the inquiry made by the specialized SLM server 200a of the operation planning department in step S1208 in FIG. 12 is made precisely.

After accepting the above-described response from the specialized SLM server 200c of the vehicle maintenance department in step S1209 in FIG. 12, the arithmetic logic unit for the specialized SLM server 200a of the operation planning department integrates the above-described response with the response accepted from the specialized SLM server 200b of the procurement department in step S1207 in FIG. 12 (step S1210 in FIG. 12). Then, based on the content obtained by integrating the plurality of responses, the response generation unit 211a is caused to send a response corresponding to the query accepted from the user terminal 300 of the operation planning department in step S1201 in FIG. 12 to the user terminal 300 of the operation planning department (step S1211 in FIG. 12). In the case illustrated by the example in FIGS. 11 and 12, the response generation unit 211a is caused to send a response to the user terminal 300 to inform that the relevant vehicle will become available in five days (see (6) in FIGS. 11 and 12). Consequently, the response is made precisely to the query transmitted by the user terminal 300 in step S1201 in FIG. 12.

Accordingly, in the processing illustrated in the sequence diagram in FIG. 12, the arithmetic logic unit for the coordinator SLM server 100 receives the query indicating the content of the prompt which the relevant user input to the user terminal 300 of the operation planning department, and the result of the primary analysis for which the query is the analysis target and which is highly probable, from the specialized SLM server 200a of the operation planning department, and performs the precise secondary analysis of the query and the result of the primary analysis. Then, in order to make a highly accurate response to the content of the inquiry indicated by the relevant query based on the result of this precise secondary analysis, an inquiry for the coordination of the specialized SLM servers 200 is made to the specialized SLM server 200b of the procurement department and the specialized SLM server 200c of the vehicle maintenance department. Consequently, the coordination of the specialized SLM servers 200 is performed precisely in order to solve the problem relating to the content of the inquiry precisely.

Furthermore, the arithmetic logic unit for the specialized SLM server 200b of the procurement department and the arithmetic logic unit for the specialized SLM server 200c of the vehicle maintenance department, which are the targets of the coordination, make full use of their specialized SLMs which they possess and which specialize in the job details of the departments where they are installed, and thereby acquire highly accurate response content regarding the check items contained in the inquiry from the specialized SLM server 200a of the operation planning department based on the result of the secondary analysis by the coordinator SLM server 100. Consequently, the highly accurate response content is obtained regarding each of the check items.

Then, the arithmetic logic unit for the specialized SLM server 200a of the operation planning department integrates the highly accurate responses obtained regarding the respective check items and outputs a final response to the query based on this integrated response. Consequently, an extremely accurate and precise response can be made to the inquiry even if the inquiry indicating the relevant query contains the cross-cutting issue like the one which requires the plurality of pieces of business knowledge as in the case illustrated by the example in FIGS. 11 and 12.

Incidentally, with the distributed AI system 1 according to this embodiment, a history of communication (a combination of inquiries and responses) performed between the coordinator SLM server 100 and the specialized SLM server 200, between the specialized SLM servers 200, and between the specialized SLM server 200 and the user terminal 300 is saved and the control unit for the coordinator SLM server 100 and/or the specialized SLM server 200 can trace the flow of a series of communication performed at the distributed AI system 1 by referring to and outputting this saved communication history as appropriate.

The distributed AI system 1 according to this embodiment and the coordinator SLM server 100 and the specialized SLM servers 200 which are the main constituent elements of the distributed AI system 1 have been described above.

The respective embodiments of the present invention described above can be summarized as follows.
(1) The information processing device (the coordinator SLM server 100) is a device for managing a plurality of machine learning models (specialized SLMs) respectively having specializations in specified fields, wherein the information processing device (the coordinator SLM server 100) includes at least a processor 101 and a storage device (102, 103), wherein the storage device (102, 103) stores: a list of the plurality of machine learning models (specialized SLMs) which are management objects; specialization information about the respective specializations of the plurality of machine learning models; and a key word for extracting a machine learning model (specialized SLM) from the list; and wherein the processor: accepts information about specialization related to an inquiry from a user; selects a machine learning model (specialized SLM) candidate which contributes to generation of response content for the inquiry, from the plurality of machine learning models (specialized SLMs) in the list based on the specialization related to the inquiry, the specialization information, and the key word; and decides a machine learning model (specialized SLM) to be used for the generation of the response content for the inquiry based on the selected machine learning model (specialized SLM) candidate. Consequently, the information processing device (the coordinator SLM server 100) can precisely conduct the coordination of the specialized SLM servers 200 equipped with the machine learning models (specialized SLMs) to be used for the generation of the response content for the relevant inquiry in order to solve the problem relating to the content of the relevant inquiry. As a result, when the information processing device (the coordinator SLM server 100) is employed, an extremely accurate and precise response can be made for the relevant inquiry even if the inquiry includes a cross-cutting issue like the one which requires a plurality of pieces of business knowledge.
(2) The storage device (102, 103) further stores cost information about cost arising when each of the machine learning models (specialized SLMs) executes processing; and wherein the processor 101 decides the machine learning model (specialized SLM) to be used for the generation of the response content for the inquiry based on the selected machine learning model (specialized SLM) candidate and the cost information about the machine learning model (specialized SLM) candidate.
(3) The storage device (102, 103) further stores communication performance information about communication performance between the machine learning models (specialized SLMs) which are the management objects; and wherein the processor 101 decides the machine learning model (specialized SLM) to be used for the generation of the response content for the inquiry based on the selected machine learning model (specialized SLM) candidate, and the cost information and the communication performance information about the machine learning model (specialized SLM) candidate.
(4) The cost information includes information about renewable energy procurement cost in an environment where each machine learning model (specialized SLM) executes processing.
(5) The machine learning model is a Small Language Model (SLM) which specializes in a field of expertise.
(6) The information processing system (the distributed AI system 1) includes at least: a plurality of machine learning models (specialized SLMs) respectively having specializations in specified fields; and an information processing device (the coordinator SLM server 100) for managing the plurality of machine learning models (specialized SLMs), wherein the information processing device (the coordinator SLM server 100) includes at least a processor 101 and a storage device (102, 103); wherein the storage device (102, 103) stores: a list of the plurality of machine learning models (specialized SLMs) which are management objects; specialization information about the respective specializations of the plurality of machine learning models; and a key word for extracting a machine learning model (specialized SLM) from the list; and wherein the processor: accepts information about specialization related to an inquiry from a user; selects a machine learning model (specialized SLM) candidate which contributes to generation of response content for the inquiry, from the plurality of machine learning models in the list based on the specialization related to the inquiry, the specialization information, and the key word; and decides a machine learning model (specialized SLM) to be used for the generation of the response content for the inquiry based on the selected machine learning model (specialized SLM) candidate.

Incidentally, the present invention is not limited to the above-described embodiment and can be implemented by using arbitrary constituent elements within the scope without departing from its gist.

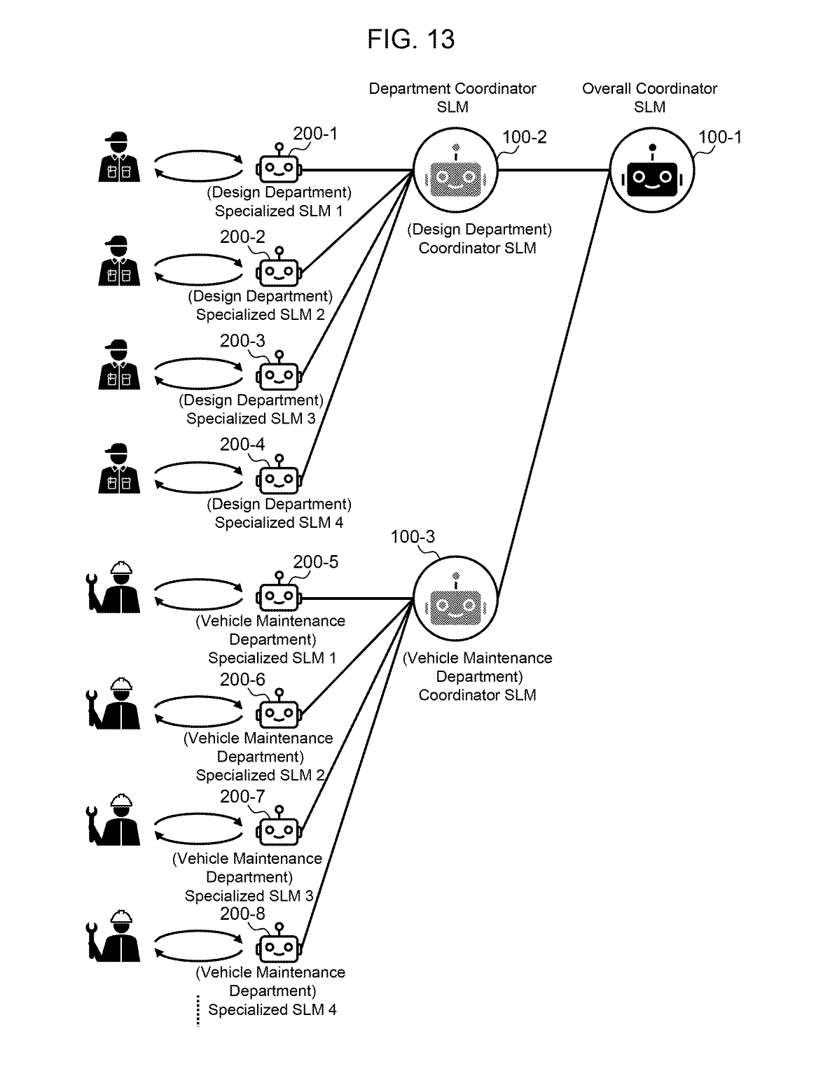

As an example, the distributed AI system 1 according to the above-described embodiment is configured from the respective specialized SLM servers 200 which specialize in the job details of the respective departments, and the coordinator SLM server 100 which has overall control of the specialized SLM servers 200. However, the distributed AI system 1 may include at least the coordinator SLM server 100 and the specialized SLM servers 200 as constituent elements. As a specific example with the distributed AI system illustrated by an example in FIG. 13, four specialized SLM servers 200-1 to 200-4 are installed in a design department as the specialized SLM servers 200 which specialize in the design department, and four specialized SLM server 200-5 to 200-8 are installed in a vehicle maintenance department as the specialized SLM servers 200 which specialize in the vehicle maintenance department. In addition, a coordinator SLM server 100-2 having overall control of only the specialized SLM servers 200-1 to 200-4 within the design department is installed at the design department and a coordinator SLM server 100-3 having overall control of only the specialized SLM servers 200-5 to 200-8 within the vehicle maintenance department is installed at the vehicle maintenance department. Then, a coordinator SLM server 100-1 having further overall control of the coordinator SLM servers 100-2 to 100-n which are installed in the respective departments of the relevant company, including the coordinator SLM server 100-2 installed in the design department and the coordinator SLM server 100-3 installed in the vehicle maintenance department, is provided as the coordinator SLM server 100 which has the overall control of the entire system of the distributed AI system. Also in this case, the distributed AI system can have operational advantages similar to those of the distributed AI system 1 according to the aforementioned embodiment.

The above-described embodiments and variations are just examples and the present invention is not limited to their content unless the features of the invention are impaired. Also, the various embodiments and variations have been described above, but the present invention is not limited to their content. Furthermore, not all these content details are necessarily required as the solving means of this invention. Other aspects which can be thought of within the scope of the technical idea of the present invention are also included within the scope of the present invention.

In each aforementioned drawing, control lines and information lines which are considered to be necessary for the explanation are indicated; however, not all control lines or information lines for implementation may be necessarily indicated. For example, it may be considered that practically almost all the components are connected to each other.

Furthermore, the aforementioned arrangement pattern of the respective functional units of the coordinator SLM server 100 and the specialized SLM server 200 explained earlier is merely one example. The arrangement pattern of the respective functional units can be changed to an optimum arrangement pattern from the viewpoint of the performance, processing efficiency, communication efficiency, etc. of the hardware and software possessed by the coordinator SLM server 100 and the specialized SLM server 200.

Furthermore, regarding each of the aforementioned configurations, functions, processing units, processing means, etc., part or whole of them may be implemented by hardware by, for example, designing it with integrated circuits, or may be implemented by software by the processor (101, 201) which is an arithmetic device by interpreting and executing a program for implementing each of the functions.

1. An information processing device for managing a plurality of machine learning models respectively having specializations in specified fields,
the information processing device comprising at least a processor and a storage device,
wherein the storage device stores:
a list of the plurality of machine learning models which are management objects;
specialization information about the respective specializations of the plurality of machine learning models; and
a key word for extracting a machine learning model from the list; and
wherein the processor:
accepts information about specialization related to an inquiry from a user;
selects a machine learning model candidate which contributes to generation of response content for the inquiry, from the plurality of machine learning models in the list based on the specialization related to the inquiry, the specialization information, and the key word; and
decides a machine learning model to be used for the generation of the response content for the inquiry based on the selected machine learning model candidate.

2. The information processing device according to claim 1,
wherein the storage device further stores cost information about cost arising when each of the machine learning models executes processing; and
wherein the processor decides the machine learning model to be used for the generation of the response content for the inquiry based on the selected machine learning model candidate and the cost information about the machine learning model candidate.

3. The information processing device according to claim 2,
wherein the storage device further stores communication performance information about communication performance between the machine learning models which are the management objects; and
wherein the processor decides the machine learning model to be used for the generation of the response content for the inquiry based on the selected machine learning model candidate, and the cost information and the communication performance information about the machine learning model candidate.

4. The information processing device according to claim 2,
wherein the cost information includes information about renewable energy procurement cost in an environment where each machine learning model executes processing.

5. The information processing device according to claim 1,
wherein the machine learning model is a Small Language Model (SLM) which specializes in a field of expertise.

6. An information processing system comprising at least:
a plurality of machine learning models respectively having specializations in specified fields; and
an information processing device for managing the plurality of machine learning models,
wherein the information processing device includes at least a processor and a storage device;
wherein the storage device stores:
a list of the plurality of machine learning models which are management objects;
specialization information about the respective specializations of the plurality of machine learning models; and
a key word for extracting a machine learning model from the list; and
wherein the processor:
accepts information about specialization related to an inquiry from a user;
selects a machine learning model candidate which contributes to generation of response content for the inquiry, from the plurality of machine learning models in the list based on the specialization related to the inquiry, the specialization information, and the key word; and
decides a machine learning model to be used for the generation of the response content for the inquiry based on the selected machine learning model candidate.

7. An information processing method for managing a plurality of machine learning models respectively having specializations in specified fields,
wherein in a computer comprising at least a processor and a storage device,
the storage device stores:
a list of the plurality of machine learning models which are management objects;
specialization information about the respective specializations of the plurality of machine learning models; and
a key word for extracting a machine learning model from the list; and
the processor:
accepts information about specialization related to an inquiry from a user;
selects a machine learning model candidate which contributes to generation of response content for the inquiry, from the plurality of machine learning models in the list based on the specialization related to the inquiry, the specialization information, and the key word; and
decides a machine learning model to be used for the generation of the response content for the inquiry based on the selected machine learning model candidate.

8. A computer program in an information processing device comprising at least a processor and a storage device and designed for managing a plurality of machine learning models respectively having specializations in specified fields,
wherein the computer program causes the storage device to store:
a list of the plurality of machine learning models which are management objects;
specialization information about the respective specializations of the plurality of machine learning models; and
a key word for extracting a machine learning model from the list; and
wherein the computer program causes the processor to execute processing for:
accepting information about specialization related to an inquiry from a user;
selecting a machine learning model candidate which contributes to generation of response content for the inquiry, from the plurality of machine learning models in the list based on the specialization related to the inquiry, the specialization information, and the key word; and
deciding a machine learning model to be used for the generation of the response content for the inquiry based on the selected machine learning model candidate.
